(19) United States
(12) Patent Application Publication
(10) Pub. No.: US 2007/0245978 A1
(43) Pub. Date: Oct. 25, 2007

(54) Aromatherapets - pet clothing, blankets and accessories with pouches for herbal packs

(76) Inventor: Cohen M. Suzanne, Monroeville, NJ (US)

Correspondence Address: Suzanne Cohen, 1473 Ferrell Rd., Monroeville, NJ, 08343, US

(21) Appl. No.: 11/408,884

(22) Filed: Apr. 24, 2006

(51) Int. Cl. A01K 13/00

(52) U.S. Cl. 119/850

(57) ABSTRACT

This is a clothing line for pets that is filled with herbal packs well known for their positive effect in the reduction of stress and pain.

### CROSS REFERENCE TO RELATED APPLICATION

This application claims benefit of Provisional Patent Application No. 60/671,896, “AROMATHERAPETS”—Pet clothing, Blankets and accessories with pouches for herbal packs filed Apr. 16, 2005, entitled” and is hereby incorporated by reference in its entirely.

### FIELD OF THE INVENTION

The present invention relates to herb-stuffed clothing and accessories, more specifically for pets.

### BACKGROUND OF THE INVENTION

The therapeutic benefit of natural herbal remedies has been recognized by mankind going as far back as cultures such as the Aborigines of Australia, the Native American Indians, to the tribes in Africa. In more modern history, companies have produced commercial lines of herbal packets for topical and aroma therapeutic use. These have proven records of successful sales to the general public.

### SUMMARY OF THE INVENTION

Clothing for Non-human animals filled with herbal packs. Includes coats, collars, and blankets.

### BRIEF DESCRIPTION OF THE DRAWINGS

FIG. 1—This is a Pet blanket filled with herbal packs. Referred to as the Petherbed Blanket Design.

FIG. 2—Petherbed blanket—Packet display and Pouch Design

FIG. 3—Petherbed Design with herbal packet inserted in pouch. Pouch using Velcro to seal packets

FIG. 4—Petticoat Design—This is a coat to be worn by a non-human animal.

FIG. 5—Petticoat Design—this is the same coat as FIG. 4 showing the opening with the herbal pack inserted.

FIG. 6—Doggie/Bone Blanket

FIG. 7—Additional view of the Petticoat Design

FIG. 8—Fish Blanket

FIG. 9—Drawing of Aromatherapets Collar

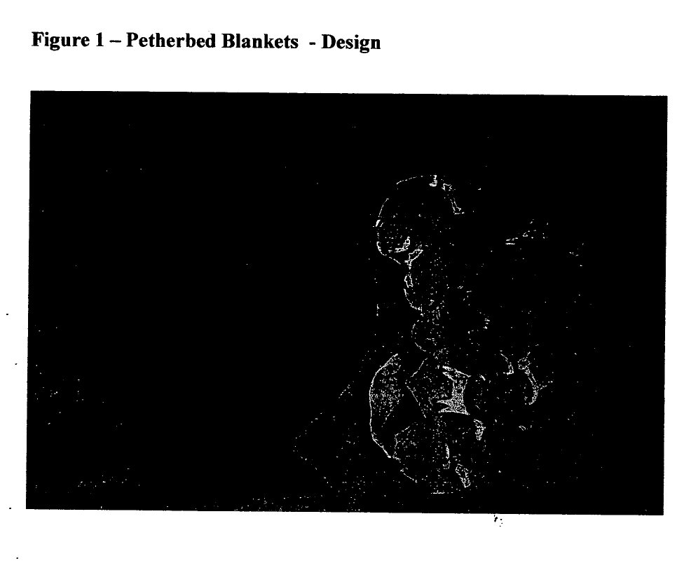

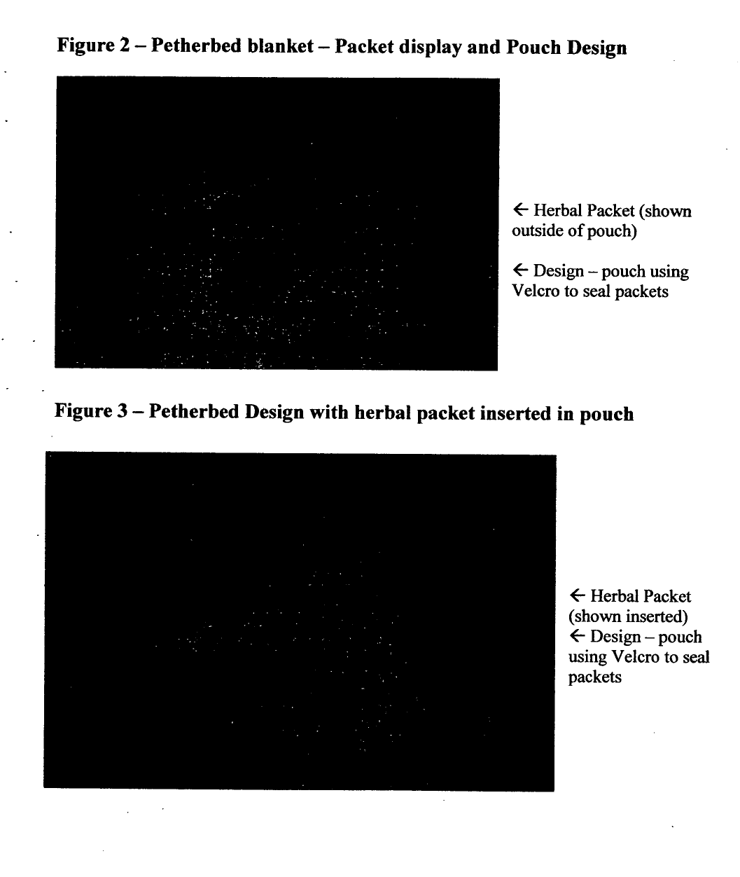

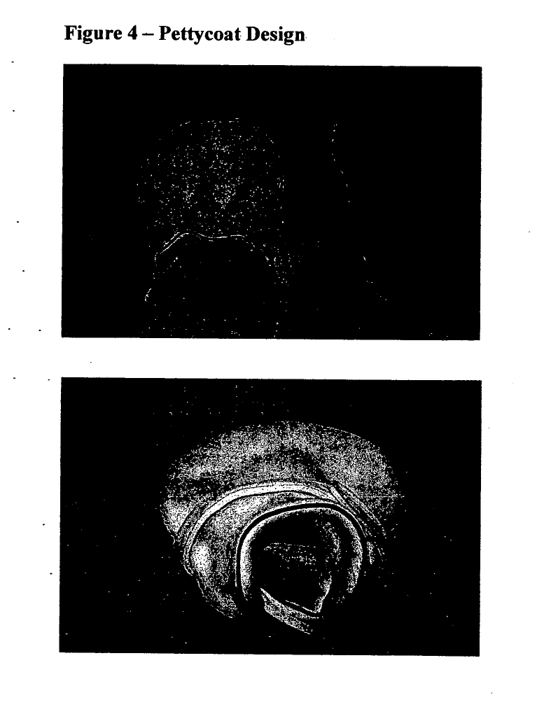

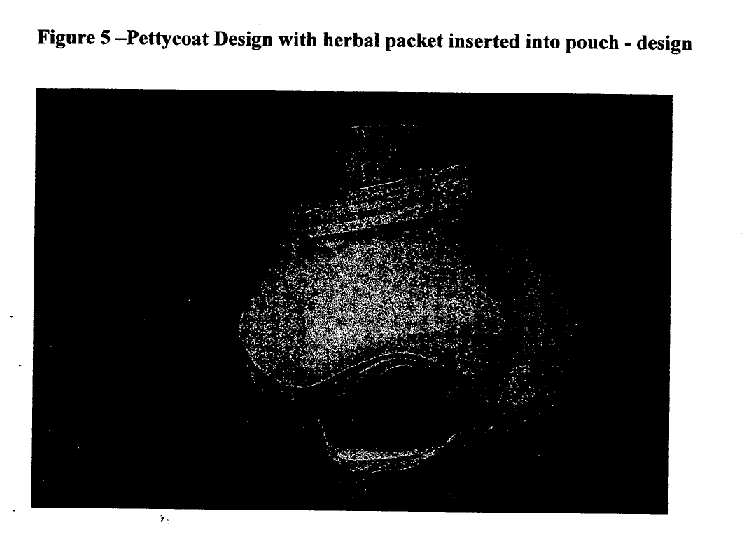

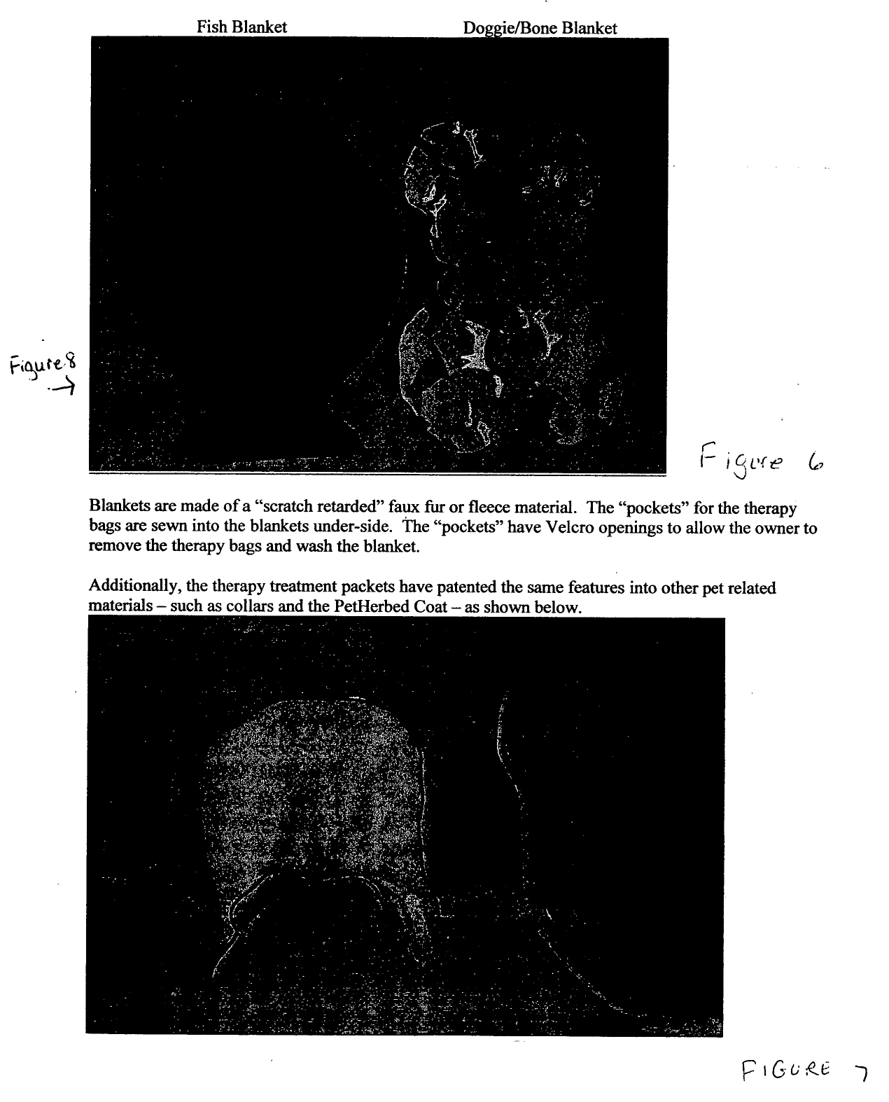

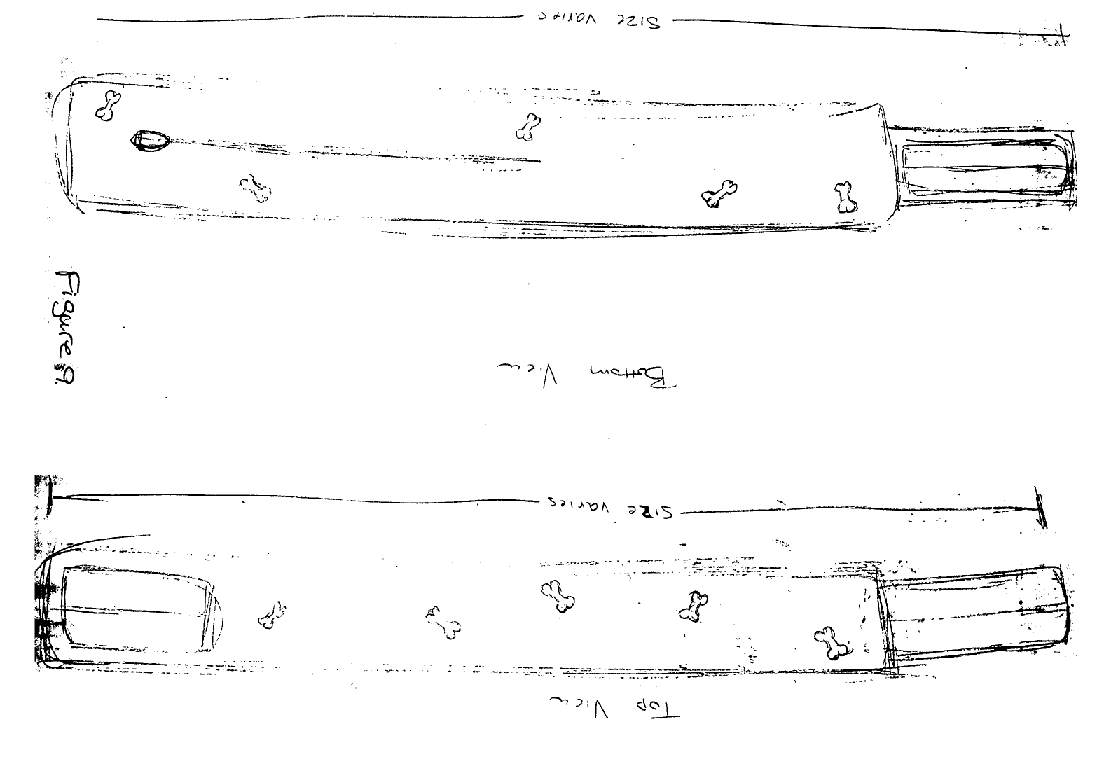

### DETAILED DESCRIPTION OF ILLUSTRATIVE EMBODIMENTS

The present invention generally relates to equipping pet related articles (collars, coats, blankets, pet clothing and accessories) with a pouch and herbal packets that are interchangeable and contain an exclusive blend of twelve muscle-relaxing pain-relieving herbs.

The widespread success has led to the next natural progression of the pet owner demanding similar benefits for these loved members of the family.

The herbal pet blankets are machine washable, and made of scratch-resistant polar-fleece material. They come in the shape of a biscuit for dogs, and the shape of a fish for cats.

The coats are also made of polar fleece material. They are lined with piping material and they unzip to remove the inner pouch. The coats may be embroidered with a name.

Collars are made with cotton plaid materials. They are approximately 15″-20″ in length. They are stuffed with herbal packs as well, and come with either zippers or Velcro for fastening. The herbal packets are removable and can be easily microwaved for a few minutes to heat them for added therapeutic benefit. Packets are sewn in sections to prevent shifting of contents.

Some can be called, The Pet-peeve retreat, The coat-of-arms, Ticked Off, The Bark of Triumph.

Herbal packs can be filled with a mixture of the following herbs, but are not limited to this combination. The following herbs are well known to have the following properties:

| | |
|---|---|
| Cinnamon | Anti-spasmodic |
| Chamomile | Relaxant |
| Lavender | Relaxant |
| Lemongrass | Relieves Pain |
| Peppermint | Relieves Pain |
| Rosemary | Relieves Headaches |
| Saw Palmetto Berry | Rejuvenator |
| Spearmint | Relaxant |
| Valerian Root | Calming, Anti-spasmodic |
| White Willow | Relieves Aches and Pains |
| Yarrow | Promotes Healing |
| Yellow Dock Root | Improves Circulation |

In addition, the combination of herbs above is known for being effective as a bug repellants.

1. An article of clothing wearable by a non-human animal. The article comprising a pouch for receiving an herb.

2. An article in accordance with claim 1, wherein the herbs are in a pack.

3. An article in accordance with claim 1 wherein the non-human animal comprises at least one of a dog, a cat, and a horse.

4. An article in accordance with claim 1 comprising at least one of a collar, a jacket, a vest, a petticoat.

5. A blanket comprising a pouch for receiving an herb.
